(19) United States
(12) Patent Application Publication
(10) Pub. No.: US 2026/0139168 A1
(43) Pub. Date: May 21, 2026

(54) ONE COMPONENT EPOXY ADHESIVE COMPOSITION

(71) Applicant: Henkel AG & Co. KGaA, Duesseldorf (DE)

(72) Inventors: Chunfu Chen, Kanagawa (JP); Shuichi Iwasaki, Kanagawa (JP); Masao Kanari, Kanagawa (JP); Daoqiang Lu, Shanghai (CN)

(21) Appl. No.: 19/446,823

(22) Filed: Jan. 12, 2026

Related U.S. Application Data
(63) Continuation of application No. PCT/CN2023/106542, filed on Jul. 10, 2023.

(51) Int. Cl. C09J 163/00; C09J 11/04; C09J 11/06; C09J 11/08

(52) U.S. Cl. CPC C09J 163/00; C09J 11/04; C09J 11/06; C09J 11/08

(57) ABSTRACT

This invention relates to one component thermal curable epoxy adhesive suitable for use in structural bonding applications on various substrates. The invented composition is composed of at least one hydrogenated bisphenol A epoxy resin, multi-functional epoxy resin, core-shell toughener and latent curing agents including dicyandiamide and accelerator. The epoxy adhesive composition according to the invention shows good stability at room temperature and fast thermal curability at elevated temperatures. Further, the present invention relates to a cured product obtained from the liquid one-component (1K) epoxy resin composition according to the invention and the cured product's use. The cured epoxy adhesive possesses very good thermal property, very strong tensile and adhesion strength as well as good reliability performance. suitable for use in structural bonding applications on various substrates.

### FIELD OF THE INVENTION

The present invention relates to a liquid one-component (1K) epoxy adhesive composition comprising a hydrogenated bisphenol A epoxy resin, a multifunctional epoxy resin, a core-shell toughener, a dicyandiamide and an accelerator. Further, the present invention relates to a cured product obtained from the liquid one-component (1K) epoxy resin composition according to the invention and the cured product's use.

### BACKGROUND OF THE INVENTION

Epoxy resins are used a broad range of application, such as bonding applications in e.g. bicycle and automobile parts assembly. The reliability of bondings in this area, i.e. in the area of transportation means, is of crucial impact for safety in all day life. Research and development focusses on the improvement of these bonding applications, wherein the cured epoxy resins should exhibit excellent chemical resistance, particularly to alkaline environments, high tensile strength and compressive strength, high fatigue strength, low shrinkage upon cure, electrical insulation properties and retention thereof upon aging or environmental exposure.

In the state of the art, one-component epoxy resin compositions are disclosed addressing improvements of their properties and the properties of the downstream applications, as e.g. disclosed in the EP 3 798 246 A1.

There are however further properties associated with room for improvements. In particular, there is a need for finding one-component epoxy adhesive compositions showing a higher thermal resistance with higher glass transition temperature and higher tensile strength properties. Such products would improve the downstream applications in the field of all transportation means. Existing epoxy adhesives are not suitable for use in high reliability performance required applications due to insufficient thermal resistance and tensile strength.

Therefore, the invention's underlaying problem relates to the provision of a one-component epoxy adhesive composition resulting in a higher thermal resistance with higher glass transition temperature and higher tensile strength properties.

### SUMMARY OF THE INVENTION

The invention's underlaying problem is solved by the subject-matter of claim 1. According to a first aspect of the invention, there is provided a one-component (1K) epoxy adhesive composition comprising, based on the weight of the composition: a) from 5 to 60 wt. % of a hydrogenated bisphenol A epoxy resin; b) from 5 to 50 wt. % of a multifunctional epoxy resin; c) from 5 to 30 wt. % of a core-shell toughener; d) from 2 to 10 wt. % of a dicyandiamide; and e) from 2 to 10 wt. % of an accelerator.

The invented composition is composed of at least one hydrogenated bisphenol A epoxy resin, at least one multi-functional epoxy resin, at least one core-shell toughener, at least one latent curing agents including dicyandiamide, and at least one accelerator. Other components such as filler, coupling agent and colorant can be combined as needed. The epoxy adhesive according to the invention shows good stability at room temperature and fast thermal curability at elevated temperatures. The cured epoxy adhesive possesses very good thermal property, very strong tensile and adhesion strength as well as good reliability performance suitable for use in structural bonding applications on various substrates.

According to a preferred embodiment, the composition according to the invention comprises, based on the weight of the composition, a) from 10 to 40 wt. % of a hydrogenated bisphenol A epoxy resin; b) from 10 to 30 wt. % of a multifunctional epoxy resin; c) from 10 to 25 wt. % of a core-shell toughener; d) from 3 to 8 wt. % of a dicyandiamide; and e) from 3 to 8 wt. % of an accelerator.

The first mandatory component of the composition according to the invention is a hydrogenated bisphenol A epoxy resin. This compound is well known for use in adhesive compositions. It is used in amounts of 5 to 60 wt. %, preferably 10 to 40 wt. %, more preferred 15 to 35 wt. %, based on the weight of the composition.

An example of a beneficial commercially available hydrogenated bisphenol A epoxy resin is the ADEKA RESIN EP-4080E, supplied from ADEKA Corporation.

The second mandatory component of the composition according to the invention is the multifunctional epoxy resin. In general, “multifunctional” means that two or more glycidyloxy-groups are present in the epoxy resin. According to a preferred embodiments of the present invention, the multifunctional epoxy resin has at least three glycidyloxy groups, more preferred three to eight glycidyloxy groups, even more preferred three, four or five glycidyloxy groups, most preferred three or four glycidyloxy groups.

The multifunctional epoxy resin is used in the composition according to the invention in an amount of 5 to 50 wt. %, preferably 10 to 30 wt. %, more preferred 15 to 25 wt. %, based on the weight of the composition.

According to a preferred embodiment, the multifunctional epoxy resin is selected from the group consisting of a multifunctional glycidyloxy-group containing phenol derivative; a multifunctional glycidyloxy-group containing bisphenol-F derivative; a multifunctional glycidyloxy-group containing bisphenol-A derivative; a multifunctional glycidyloxy-group containing amino phenol derivative, in particular a multifunctional glycidyloxy-group containing para-amino phenol derivative or a multifunctional glycidyloxy-group containing meta-amino phenol derivative; a multifunctional glycidyloxy-group containing methylene dianiline derivative; and mixtures thereof.

All multifunctional epoxy resins may include those in which the aromatic rings of the multifunctional epoxy resins are substituted or non-substituted. The skilled person understands the meaning of the above derivatives. A multifunctional glycidyloxy-group containing bisphenol-F derivative comprises a bisphenol-F moiety substituted with glycidyloxy-groups, preferably more than three glyciyloxy-groups. The aromatic rings of the bisphenol-F moieties may be substituted or non-substituted with substituents other than the glycidyloxy-groups. The multifunctional glycidyloxy-group containing bisphenol-A derivative is a specie distinguishing from the first mandatory component of the compositions of the invention, as will be understood by a person skilled in the art.

Examples of beneficial multifunctional epoxy resins are triglycidylether of para-amino phenol (TGPAP), as the commercially available products Araldite™ MY 0500 or 0510 from Huntsman Inc., or triglycidylether of meta-amino phenol (TGMAP), as the commercially available products Araldite™ MY 0600 or 0610 from Huntsman Inc., or the tetraglycidylether of methylene dianiline (TGMDA), as he commercially available products Araldite™ MY 720, 721 or 9512 from Huntsman Inc., or the ethyl-substituted TGMDA, as the commercially available product Araldite™ MY 722 or 0510 from Huntsman Inc.

A further preferred multifunctional epoxy resin is a multifunctional glycidyloxy-group containing diamino xylylene derivative, more preferred an ortho-diamino xylylene derivative or a meta-diamino xylylene derivative, in particular glycidyl amine type epoxy resin as the commercially available product TETRAD-X, manufactured by Mitsubishi Gas Chemical Company Inc.

As for an alternative multifunctional epoxy resin, the composition may comprise a multifunctional epoxy resin being a polymeric multifunctional glycidyloxy-group containing resin. Preferably, the multifunctional epoxy resin is a multifunctional glycidyloxy-group containing phenol novolac having a functionality of 2.5 to 4.0, preferably from 2.7 to 3.8, more preferred from 3.0 to 3.6.

The term “functionality” is understood such that the average number of glycidyloxy-groups per polymeric molecule represents the value called “functionality”.

Examples of commercially available polymeric multifunctional glycidyloxy-group containing resins are the Epoxy Phenol Novolacs Araldite™ GY 289, EPN 9850, PY 307-1, EPN 1179, EPN 9881, EPN 1180 available from Huntsman.

The third mandatory component of the composition according to the invention is the core-shell toughener. According to a preferred embodiment, the core-shell toughener comprises core-shell rubber particles.

The term “core shell rubber” or CSR is being employed in accordance with its standard meaning in the art as denoting a rubber particle core formed by a polymer comprising an elastomeric or rubbery polymer as a main ingredient and a shell layer formed by a polymer which is graft polymerized onto the core. The shell layer partially or entirely covers the surface of the rubber particle core in the graft polymerization process. By weight, the core should constitute at least 50 wt. % of the core-shell rubber particle.

The core-shell toughener is used in the composition according to the invention in an amount of 5 to 30 wt. %, preferably 10 to 25 wt. %, more preferred 10 to 15 wt. %, based on the weight of the composition.

The core of the core-shell rubber particles may comprise a diene homopolymer. In one preferred embodiment the diene homopolymer is a homopolymer of butadiene or isoprene. In a further embodiment, the core-shell rubber particles may comprise a diene copolymer being more preferred a copolymer of butadiene with one or more of vinyl aromatic monomer, (meth)acrylonitrile, and (meth)acrylate, or a diene copolymer being more preferred a copolymer of isoprene with one or more of vinyl aromatic monomer, (meth)acrylonitrile, and (meth)acrylate. In a further embodiment, the core-shell rubber particles may comprise polymers based on (meth)acrylic acid ester monomers, more preferred polybutylacrylate; or polysiloxane elastomers, more preferred polydimethylsiloxane or crosslinked polydimethylsiloxane.

The polymeric material of the core should have a glass transition temperature (Tg) of no greater than 0° C. and preferably a glass transition temperature (Tg) of −20° C. or lower, more preferably −40° C. or lower and even more preferably −60° C. or lower.

In further embodiments, the core-shell toughener may comprises core-shell rubber particles, wherein preferably the shall of the core-shell rubber particles comprises a polymer or copolymer of one or more monomers selected from (meth)acrylates, more preferred methyl methacrylate; vinyl aromatic monomers, more preferred styrene; vinyl cyanides, more preferred acrylonitrile; unsaturated acids or anhydrides, more preferred acrylic acid; or (meth)acrylamides.

The polymer of the shell is non-elastomeric, thermoplastic or thermoset polymer having a glass transition temperature (Tg) of greater than room temperature, preferably greater than 30° C. and more preferably greater than 50° C.

According to a further preferred embodiment, the core-shell rubber particles have an average particle size (d50) of from 10 nm to 300 nm, preferably from 50 nm to 200 nm, more preferred from 80 to 150 nm, wherein said particle size refers to the diameter or largest dimension of a particle in a distribution of particles being measured via dynamic light scattering.

The present application does not preclude the presence of two types of core shell rubber (CSR) particles with different particle sizes in the composition to provide a balance of key properties of the resultant cured product, including shear strength, peel strength and resin fracture toughness. In this embodiment, smaller included particles (1st CSR type) may have an average particle size of from 10 to 100 nm and larger included particles (2nd CSR type) may have an average particle size of from 120 nm to 300 nm, for example from 150 to 300 nm. The smaller core shell rubber particles should typically be employed in excess of the larger particles on a weight basis: a weight ratio of smaller CSR particles to larger CSR particles of from 3:1 to 5:1 may be employed for instance.

The fourth mandatory component of the composition according to the invention is the dicyandiamide being a curative.

The dicyandiamide is used in the composition according to the invention in an amount of 2 to 10 wt. %, preferably 3 to 8 wt. %, more preferred 3.5 to 5.5 wt. %, based on the weight of the composition.

According to a further preferred embodiment, the dicyandiamide has a particulate form characterized by an average particle size (d50) of from 0.5 to 100 μm, preferably from 1 to 50 μm, more preferred from 2 to 25 μm, as measured by dynamic light scattering.

The fifth mandatory component of the composition according to the invention is the accelerator. The term “accelerator” as used herein refers to a chemical agent that is co-reactive with the curative and which reduces the cure time of the composition relative to that achievable with said curative alone under equivalent conditions.

The accelerator is used in the composition according to the invention in an amount of 2 to 10 wt. %, preferably 3 to 8 wt. %, more preferred 3.5 to 5.5 wt. %, based on the weight of the composition.

According to a preferred embodiment, the accelerator is a urea derivative. More preferred, the accelerator is a urea derivative comprising at least one urea derivative of Formula (I) or Formula (II):

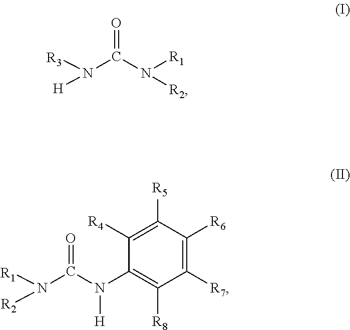

wherein
at least one residue R¹, R², R³ is not hydrogen;
R¹ and R² are independently selected from hydrogen, C₁-C₁₈ alkyl and C₃-C₁₈ cycloalkyl;
R³ is hydrogen, C₁-C₁₈ alkyl, C₃-C₁₈ cycloalkyl, C₆-C₁₈ aryl, C₆-C₁₈ aralkyl, C₆-C₁₈-alkylaryl, C₁-C₁₈ alkyl substituted with —NHC(O)NR¹R², C₃-C₁₈ cycloalkyl substituted with —NHC(O)NR¹R², C₆-C₁₈ aryl substituted with —NHC(O)NR¹R²; C₆-C₁₈ aralkyl substituted with —NHC(O)NR¹R²; and, C₆-C₁₈ aralkyl substituted with —NHC(O)NR¹R²; and R⁴, R⁵, R⁶, R⁷ and R⁸ are independently selected from hydrogen, halogen, C₁-C₁₈ alkyl, C₃-C₁₈ cycloalkyl, C₆-C₁₈ aryl, C₆-C₁₈ aralkyl, C₆-C₁₈-alkylaryl, —CF₃, —NHC(O)NR¹R², C₁-C₁₈ alkyl substituted with —NHC(O)NR¹R², C₃-C₁₈ cycloalkyl substituted with —NHC(O)NR¹R², C₆-C₁₈ aryl substituted with —NHC(O)NR¹R²; C₆-C₁₈ aralkyl substituted with —NHC(O)NR¹R²; and, C₆-C₁₈ aralkyl substituted with —NHC(O)NR¹R².

In a preferred embodiment, the urea derivative is selected from the group consisting of N,N-diethylurea, N,N-dipropylurea, N,N-ethyl-methylurea, N,N-dimethylurea, 1,1′-(4-methyl-m-phenylene)-bis-(3,3-dimethylurea) and 1,1′-(2-methyl-m-phenylene)-bis-(3,3-dimethylurea).

When said ureas are employed as accelerators, it is very preferred that the molar ratio of dicyandiamide to the total of said urea derivatives is 1 and is preferably in the range from 1:1 to 4:1, for example from 1:1 to 3:1.

Besides the mandator components of the composition according to the invention, the composition may comprise a filler and/or an adjunct ingredient.

Therefore, the composition according to a preferred embodiment further comprises f) from 0 to 60 wt. % of a filler; and/or g) from 0 to 20 wt. % of an adjunct ingredient.

According to a preferred embodiment, the filler is an organic filler or an inorganic filler. More preferred the filler is selected from the group consisting of chalk, lime powder, precipitated and/or pyrogenic silica, zeolites, bentonites, magnesium carbonate, diatomite, alumina, clay, talc, titanium oxide, iron oxide, zinc oxide, sand, quartz, flint, mica, glass powder, carbon black, graphite, wood fibers, wood flour, sawdust, cellulose, cotton, pulp, cotton, wood chips, chopped straw, chaff, ground walnut shells, glass fibers, glass filament, polyacrylonitrile, carbon fibers, Kevlar fibers, polyethylene fibers, aluminum powder, and mixtures thereof.

In an even more preferred embodiment, the filler is selected from the group consisting of silica, carbon black, aluminum powder, and mixtures thereof.

The pyrogenic and/or precipitated silica advantageously have a BET surface area from 10 to 90 m²/g. When they are used, they do not cause any additional increase in the viscosity of the composition according to the present invention, but do contribute to strengthening the cured composition. It is likewise conceivable to use pyrogenic and/or precipitated silica having a higher BET surface area, advantageously from 100 to 250 m2/g, in particular from 110 to 170 m2/g, as a filler. Because of the greater BET surface area, the effect of strengthening the cured composition is achieved with a smaller proportion by weight of silica.

According to a preferred embodiment, the adjunct ingredient is a pigment, a stabilizer, a plasticizer, a coupling agent, antioxidant, rheological adjuvants, or a mixture thereof.

According to a more preferred embodiment, the adjunct ingredient is a coupling agent selected from the group consisting of glycidoxy polymethylene trialkoxysilanes, more preferred 3-glycidoxy-1-propyl-trimethoxysilane; (meth)acryloxypolymethylene trialkoysilanes, more preferred 3-methacrylyloxy-1-propyltrimethoxysilane; gamma-methacryloxypropyltrimethoxysilane; gamma-glycidoxypropyltrimethoxysilane; alpha-glycidoxypropylmethyldiethoxysilane; vinyl-tris-(2-methoxyethoxy)silane; and alpha-chloropropyltrimethoxysilane.

An example of a coupling agent being commercially available and conferring beneficial effects to the composition of the present invention is Silquest A 187, available from Momentive Performance Materials.

The invention's underlaying problem is solved by the subject-matter of claim 13. According to a second aspect of the invention, there is provided a cured product obtained from the one-component (1K) epoxy adhesive composition according to the invention.

The cured product provides very good thermal properties, strong tensile and adhesion strength by combination of hydrogenated bisphenol A epoxy resin with multi-functional epoxy resin, core-shell toughener with latent curing agents and accelerator.

According to a preferred embodiment of the invention, the cured product is obtained by heating the one-component (1K) epoxy adhesive composition.

The invention's underlaying problem is solved by the subject-matter of claim 15. According to a third aspect of the invention, there is provided the use of a cured product according to the invention as an adhesive, a coating, a sealant or in a composite material.

Features of referred embodiments being disclosed in combination with a specific aspect should be deemed to be disclosed as features of preferred embodiments for all other aspects. As such, e.g. the features designated as preferred embodiments disclosed in combination with the liquid one-component (1K) epoxy resin composition as the first aspect are deemed to be disclosed as features of preferred embodiments of the cured product as the second aspect or preferred embodiments of the use of the cured product as the third aspect.

In the following, exemplary embodiments (A) to (E) are disclosed which represent particularly preferred embodiments.

### (A)

A one-component (1K) epoxy adhesive composition comprising, based on the weight of the composition: a) from 5 to 60 wt. % of a hydrogenated bisphenol A epoxy resin; b) from 5 to 50 wt. % of a multifunctional epoxy resin; c) from 5 to 30 wt. % of a core-shell toughener; d) from 2 to 10 wt. % of a dicyandiamide; and e) from 2 to 10 wt. % of an accelerator, wherein the multifunctional epoxy resin is selected from the group consisting of a multifunctional glycidyloxy-group containing phenol derivative; a multifunctional glycidyloxy-group containing bisphenol-F derivative; a multifunctional glycidyloxy-group containing bisphenol-A derivative; a multifunctional glycidyloxy-group containing amino phenol derivative, in particular a multifunctional glycidyloxy-group containing para-amino phenol derivative or a multifunctional glycidyloxy-group containing meta-amino phenol derivative; a multifunctional glycidyloxy-group containing methylene dianiline derivative; a multifunctional glycidyloxy-group containing diamino xylylene derivative, more preferred an ortho-diamino xylylene derivative or a meta-diamino xylylene derivative.

### (B)

A one-component (1K) epoxy adhesive composition comprising, based on the weight of the composition: a) from 5 to 60 wt. % of a hydrogenated bisphenol A epoxy resin; b) from 5 to 50 wt. % of a multifunctional epoxy resin; c) from 5 to 30 wt. % of a core-shell toughener; d) from 2 to 10 wt. % of a dicyandiamide; and e) from 2 to 10 wt. % of an accelerator, wherein the multifunctional epoxy resin is a multifunctional glycidyloxy-group containing phenol novolac having a functionality of 2.5 to 4.0, preferably from 2.7 to 3.8, more preferred from 3.0 to 3.6.

### (C)

A one-component (1K) epoxy adhesive composition comprising, based on the weight of the composition: a) from 5 to 60 wt. % of a hydrogenated bisphenol A epoxy resin; b) from 5 to 50 wt. % of a multifunctional epoxy resin; c) from 5 to 30 wt. % of a core-shell toughener; d) from 2 to 10 wt. % of a dicyandiamide; and e) from 2 to 10 wt. % of an accelerator, wherein the multifunctional epoxy resin is selected from the group consisting of a multifunctional glycidyloxy-group containing phenol derivative; a multifunctional glycidyloxy-group containing bisphenol-F derivative; a multifunctional glycidyloxy-group containing amino phenol derivative; a multifunctional glycidyloxy-group containing methylene dianiline derivative; and a multifunctional glycidyloxy-group containing diamino xylylene derivative; and wherein

### (D)

A one-component (1K) epoxy adhesive composition comprising, based on the weight of the composition: a) from 5 to 60 wt. % of a hydrogenated bisphenol A epoxy resin; b) from 5 to 50 wt. % of a multifunctional epoxy resin; c) from 5 to 30 wt. % of a core-shell toughener; d) from 2 to 10 wt. % of a dicyandiamide; and e) from 2 to 10 wt. % of an accelerator, wherein the multifunctional epoxy resin is selected from the group consisting of a multifunctional glycidyloxy-group containing phenol derivative; a multifunctional glycidyloxy-group containing bisphenol-F derivative; a multifunctional glycidyloxy-group containing amino phenol derivative; a multifunctional glycidyloxy-group containing methylene dianiline derivative; and a multifunctional glycidyloxy-group containing diamino xylylene derivative; and wherein the polymeric material of the core of the core-shell toughener has a glass transition temperature (Tg) of no greater than 0° C. and preferably a glass transition temperature (Tg) of −20° C. or lower, more preferably −40° C. or lower and even more preferably −60° C. or lower; and wherein the polymer of the shell of the core-shell toughener is non-elastomeric, thermoplastic or thermoset polymer having a glass transition temperature (Tg) of greater than room temperature, preferably greater than 30° C. and more preferably greater than 50° C.

### (E)

A one-component (1K) epoxy adhesive composition comprising, based on the weight of the composition: a) from 5 to 60 wt. % of a hydrogenated bisphenol A epoxy resin; b) from 5 to 50 wt. % of a multifunctional epoxy resin; c) from 5 to 30 wt. % of a core-shell toughener; d) from 2 to 10 wt. % of a dicyandiamide; and e) from 2 to 10 wt. % of an accelerator, wherein the multifunctional epoxy resin is selected from the group consisting of a multifunctional glycidyloxy-group containing phenol derivative; a multifunctional glycidyloxy-group containing bisphenol-F derivative; a multifunctional glycidyloxy-group containing amino phenol derivative; a multifunctional glycidyloxy-group containing methylene dianiline derivative; and a multifunctional glycidyloxy-group containing diamino xylylene derivative; and wherein the urea derivative is selected from the group consisting of N,N-diethylurea, N,N-dipropylurea, N,N-ethyl-methylurea, N,N-dimethylurea, 1,1′-(4-methyl-m-phenylene)-bis-(3,3-dimethylurea) and 1,1′-(2-methyl-m-phenylene)-bis-(3,3-dimethylurea).

### EXAMPLES

The following compounds and materials are employed in the Examples:
ADEKA RESIN EP-4080E: hydrogenated bisphenol A epoxy resin, supplied from
ADEKA Corporation
TETRAD-X: multi-functional epoxy resin, supplied from Mitsubishi Gas Chemical Company, Inc.
ZEFIAC F351: core shell toughener, supplied from Aica Kogyo Co. Ltd.
DICYANEX 1400F: dicyandiamide, supplied from Evonik Corporation
AMICURE UR2T: Substituted urea-based accelerator [1,1′-(4 methyl-m-phenylene)bis(3,3 dimethyl urea)], supplied from Evonik Corporation
SILQUEST A 187 silane coupling agent, supplied from Momentive Performance Materials
90-EPX-04 carbon black premix, supplied from Harwick Chemical
CAB-O-SIL TS-720 fumed silica, supplied from Cabot Corporation
Aluminum paste (aluminum premix in epoxy resin, supplied from Henkel)

The ingredients were combined in the percentages given in Table 1 herein below.

TABLE 1

| Ingredient | Example 1 | Example 2 |
|---|---|---|
| EP-4080E | 16.3% | 20.0% |
| TETRAD-X | 19.2% | 20.0% |
| ZEFIAC F351 | 13.5% | 17.0% |
| DICYANEX 1400F | 3.8% | 4.5% |
| AMICURE UR2T | 3.8% | 4.5% |
| SILQUEST A 187 | 0.5% | 0.5% |
| 90-EPX-04 | 2.4% | 2.5% |
| CAB-O-SIL TS- | 1.9% | 2.0% |
| 720 | | |
| Aluminum paste | 38.6% | 29% |

### Comparative Example

As for a comparison, the commercial product LOCTITE EA 9502, a 1K epoxy adhesive from Henkel was evaluated.

The viscosity was measured as follows:

Viscosities of the compositions described herein are, unless otherwise stipulated, measured using the HAAKE RheoStress 3000 at standard conditions of 23° C. and 50% Relative Humidity (RH). Measurements of the compositions are done using the Cone C35/2°.

The Differential Scanning Calorimetrv (DSC) Cure Test was performed as follows:

Samples of Example 1 were selected and tested by DSC isothermal method. More specifically, a 10.0 mg sample of the composition was individually weighed out on a milligram balance, enclosed in a hermetically sealed aluminum DSC pan, and loaded into a Perkin Elmer DSC 8000 analyzer together with an identical empty pan to be used as a reference. The heat generation was measured for 60 minutes with setting temperature at 140° C. Cure behavior was analyzed from the resulting thermographs and the cure time at 95% conversion rate at 140° C. curing was determined.

The lap shear strength is defined and measured as follows:

The “lap shear strength” is defined as the shear strength of adhesives for bonding materials when tested on a single-lap-joint specimen. The test is applicable for determining adhesive strengths, surface preparation parameters and adhesive environmental durability. As used herein, lap shear tests were performed by bonding of two aluminum coupons (2.5 cm×10 cm×0.16 cm) via an overlap according to ASTM D1002 10(2019) Standard Test Method.

Table 2 shows the results of Example 1 and Example 2:

| | Example 1 | | Example 2 | | Comparative | |
|---|---|---|---|---|---|---|
| Appearance | black past | | black past | | black past | |
| Viscosity | 148,200 | | 175,000 | | 30,000 | |
| | mPas/25° C. | | mPas/25° C. | | mPas/25° C. | |
| DSC cure behavior | 13.0 | | 7.6 | | 10.8 | |
| (95% conversion | minutes | | minutes | | minutes | |
| rate at 140° C. cure) | | | | | | |
| Tg (measured by | 123° | C. | 123° | C. | 97° | C. |
| DSC) | | | | | | |
| Tensile strength | 71.9 | MPa | 70.7 | MPa | 55.1 | MPa |
| Lap shear strength | 30.3 | MPa | 31.6 | MPa | 29.6 | MPa |
| (on Al) | | | | | | |

What is claimed is:

1. A one-component (1K) epoxy adhesive composition comprising, based on the weight of the composition:
a) from 5 to 60 wt. % of a hydrogenated bisphenol A epoxy resin;
b) from 5 to 50 wt. % of a multifunctional epoxy resin;
c) from 5 to 30 wt. % of a core-shell toughener;
d) from 2 to 10 wt. % of a dicyandiamide; and
e) from 2 to 10 wt. % of an accelerator.

2. The composition according to claim 1, which comprises, based on the weight of the composition:
a) from 10 to 40 wt. % of a hydrogenated bisphenol A epoxy resin;
b) from 10 to 30 wt. % of a multifunctional epoxy resin;
c) from 10 to 25 wt. % of a core-shell toughener;
d) from 3 to 8 wt. % of a dicyandiamide; and
e) from 3 to 8 wt. % of an accelerator.

3. The composition according to claim 1, wherein the composition further comprises
f) from 0 to 60 wt. % of a filler; and/or
g) from 0 to 20 wt. % of an adjunct ingredient.

4. The composition according to claim 1, wherein the multifunctional epoxy resin has at least three glycidyloxy groups.

5. The composition according to claim 1, wherein the multifunctional epoxy resin is selected from the group consisting of a multifunctional glycidyloxy-group containing phenol derivative; a multifunctional glycidyloxy-group containing bisphenol-F derivative; a multifunctional glycidyloxy-group containing bisphenol-A derivative; a multifunctional glycidyloxy-group containing amino phenol derivative, in particular a multifunctional glycidyloxy-group containing para-amino phenol derivative or a multifunctional glycidyloxy-group containing meta-amino phenol derivative; a multifunctional glycidyloxy-group containing methylene dianiline derivative; and mixtures thereof.

6. The composition according to claim 1, wherein the multifunctional epoxy resin is a polymeric multifunctional glycidyloxy-group containing resin, or the multifunctional epoxy resin is a multifunctional glycidyloxy-group containing phenol novolac having a functionality of 2.5 to 4.0.

7. The composition according to claim 1, wherein the core-shell toughener comprises core-shell rubber particles, wherein preferably the core of the core-shell rubber particles comprises a diene homopolymer, more preferred a homopolymer of butadiene or isoprene; a diene copolymer, more preferred a copolymer of butadiene with one or more of vinyl aromatic monomer, (meth)acrylonitrile, and (meth)acrylate, or a copolymer of isoprene with one or more of vinyl aromatic monomer, (meth)acrylonitrile, and (meth)acrylate; polymers based on (meth)acrylic acid ester monomers, more preferred polybutylacrylate; or polysiloxane elastomers, more preferred polydimethylsiloxane or crosslinked polydimethylsiloxane; and/or
wherein the core-shell toughener comprises core-shell rubber particles, wherein preferably the shall of the core-shell rubber particles comprises a polymer or copolymer of one or more monomers selected from (meth)acrylates, more preferred methyl methacrylate; vinyl aromatic monomers, more preferred styrene; vinyl cyanides, more preferred acrylonitrile; unsaturated acids or anhydrides, more preferred acrylic acid; or (meth)acrylamides.

8. The composition according to claim 1, wherein core-shell rubber particles have an average particle size (d50) of from 10 nm to 300 nm, wherein said particle size refers to the diameter or largest dimension of a particle in a distribution of particles being measured via dynamic light scattering.

9. The composition according to claim 1, wherein the dicyandiamide has a particulate form characterized by an average particle size (d50) of from 0.5 to 100 μm as measured by dynamic light scattering.

10. The composition according to claim 1, wherein the accelerator is a urea derivative, preferably wherein the accelerator is a urea derivative comprising at least one urea derivative of Formula (I) or Formula (II): 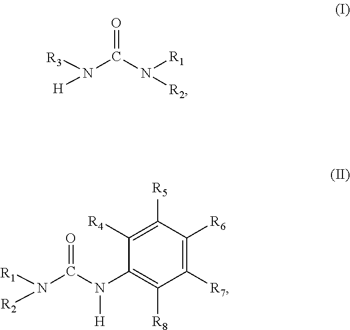
wherein
at least one residue R¹, R², R³ is not hydrogen;
R¹ and R² are independently selected from hydrogen, C₁-C₁₈ alkyl and C₃-C₁₈ cycloalkyl;
R³ is hydrogen, C₁-C₁₈ alkyl, C₃-C₁₈ cycloalkyl, C₆-C₁₈ aryl, C₆-C₁₈ aralkyl, C₆-C₁₈-alkylaryl, C₁-C₁₈ alkyl substituted with —NHC(O)NR¹R², C₃-C₁₈ cycloalkyl substituted with —NHC(O)NR¹R², C₆-C₁₈ aryl substituted with —NHC(O)NR¹R²; C₆-C₁₈ aralkyl substituted with —NHC(O)NR¹R²; and, C₆-C₁₈ aralkyl substituted with —NHC(O)NR¹R²; and R⁴, R⁵, R⁶, R⁷ and R⁸ are independently selected from hydrogen, halogen, C₁-C₁₈ alkyl, C₃-C₁₈ cycloalkyl, C₆-C₁₈ aryl, C₆-C₁₈ aralkyl, C₆-C₁₈-alkylaryl, —CF₃, —NHC(O)NR¹R², C₁-C₁₈ alkyl substituted with —NHC(O)NR¹R², C₃-C₁₈ cycloalkyl substituted with —NHC(O)NR¹R², C₆-C₁₈ aryl substituted with —NHC(O)NR¹R²; C₆-C₁₈ aralkyl substituted with —NHC(O)NR¹R²; and, C₆-C₁₈ aralkyl substituted with —NHC(O)NR¹R², wherein more preferred the urea derivative is selected from the group consisting of N,N-diethylurea, N,N-dipropylurea, N,N-ethyl-methylurea, N,N-dimethylurea, 1,1′-(4-methyl-m-phenylene)-bis-(3,3-dimethylurea) and 1,1′-(2-methyl-m-phenylene)-bis-(3,3-dimethylurea).

11. The composition according to claim 3, wherein the filler is an organic filler or an inorganic filler, preferably wherein the filler is selected from the group consisting of chalk, lime powder, precipitated and/or pyrogenic silica, zeolites, bentonites, magnesium carbonate, diatomite, alumina, clay, talc, titanium oxide, iron oxide, zinc oxide, sand, quartz, flint, mica, glass powder, carbon black, graphite, wood fibers, wood flour, sawdust, cellulose, cotton, pulp, cotton, wood chips, chopped straw, chaff, ground walnut shells, glass fibers, glass filament, polyacrylonitrile, carbon fibers, Kevlar fibers, polyethylene fibers, aluminum powder, and mixtures thereof, wherein more preferred the filler is selected from the group consisting of silica, carbon black, and aluminum powder.

12. The composition according to claim 3, wherein the adjunct ingredient is a pigment, a stabilizer, a plasticizer, a coupling agent, antioxidant, rheological adjuvants, or a mixture thereof; wherein preferably, the adjunct ingredient is a coupling agent selected from the group consisting of glycidoxy polymethylene trialkoxysilanes, more preferred 3-glycidoxy-1-propyl-trimethoxysilane; (meth)acryloxypolymethylene trialkoysilanes, more preferred 3-methacrylyloxy-1-propyltrimethoxysilane; gamma-methacryloxypropyltrimethoxysilane; gamma-glycidoxypropyltrimethoxysilane; alpha-glycidoxypropylmethyldiethoxysilane; vinyl-tris-(2-methoxyethoxy)silane; and alpha-chloropropyltrimethoxysilane.

13. A cured product obtained from the one-component (1K) epoxy adhesive composition according to claim 1.

14. The cured product according to claim 13, which is obtained by heating the one-component (1K) epoxy adhesive composition.
